(19) United States
(12) Patent Application Publication
(10) Pub. No.: US 2019/0366605 A1
(43) Pub. Date: Dec. 5, 2019

(54) ASSEMBLY INJECTION-MOLDING METHOD FOR MANUFACTURING A MOTOR VEHICLE AIR FLAP APPARATUS

(71) Applicant: Röchling Automotive SE & Co. KG, Mannheim (DE)

(72) Inventors: Riccardo Dorigatti, Seeheim-Jugenheim (DE); Jürgen Schneider, Worms (DE)

(21) Appl. No.: 16/424,814

(22) Filed: May 29, 2019

(30) Foreign Application Priority Data
Jun. 4, 2018 (DE) 10 2018 208 747.4

(51) Int. Cl. B29C 45/16; B60K 11/08

(52) U.S. Cl. CPC B29C 45/16; B29L 2031/30; B60K 11/085

(57) ABSTRACT

A method for manufacturing a motor vehicle air flap apparatus for quantitatively controlling a cooling air flow in a vehicle space, the air flap apparatus encompassing: an apparatus frame having a passthrough opening; at least one air flap that extends along a flap axis and is mounted on the apparatus frame pivotably, around a pivot axis parallel to the flap axis or coaxial therewith, between two operational positions providing different coverage of the passthrough opening; such that the method for manufacturing at least some of the components of the motor vehicle air flap apparatus encompasses an injection-molding method; the method encompasses, for the manufacture of at least two components of the motor vehicle air flap apparatus which are connected to one another by positive engagement, an assembly injection-molding step with which one of the two components is manufactured in local positive engagement with the respective other component.

The present invention relates to a method for manufacturing a motor vehicle air flap apparatus for quantitatively controlling a cooling air flow in a vehicle space, the air flap apparatus encompassing: an apparatus frame having a passthrough opening; at least one air flap that extends along a flap axis and is mounted on the apparatus frame pivotably, around a pivot axis parallel to the flap axis or coaxial therewith, between two operational positions providing different coverage of the passthrough opening; such that the method for manufacturing at least some of the components of the motor vehicle air flap apparatus encompasses an injection-molding method.

### BACKGROUND OF THE INVENTION

A method according to the present invention is known from EP 3 210 811 A1. This document discloses a multi-part injection-molded apparatus frame as well as multi-part air flaps that each comprise an extruded flap body having injection-molded end caps and, embodied in one piece thereon, pivot bearing configurations for pivotable mounting of the air flaps on the apparatus frame. The motor vehicle air flap apparatus known from EP 3 210 811 A1 comprises a plurality of mutually parallel air flaps that each comprise entraining arms that are connected to one another via a connecting strut for movement together. It is thus sufficient to drive one air flap, or the connecting strut, to move in order to drive all the air flaps, coupled via the connecting strut, to move together between the operational positions providing different coverage.

The numerous individual parts of the motor vehicle air flap apparatus known from EP 3 210 811 A1 require a plurality of injection molds, as well as considerable installation outlay, in order to produce a functional motor vehicle air flap apparatus from the individual parts.

### SUMMARY OF THE INVENTION

An object of the present invention is therefore to optimize the manufacturing method that is known, or at least derivable, from EP 3 210 811 A1 so that the number of molds required, and/or the number of installation steps that are necessary, can be reduced.

The present invention achieves this object by way of the method recited previously for manufacturing a motor vehicle air flap apparatus, which method encompasses, for the generation of at least two components of the motor vehicle air flap apparatus which are connected to one another by positive engagement, an assembly injection-molding step with which one of the two components is manufactured in local positive engagement with the respective other component.

Of the two components connected to one another by positive engagement, that component which is manufactured earlier thus forms an insert or a core in its injection-molding cavity for the component manufactured later. The term “insert” here is not to be understood procedurally in the sense that the component is actively inserted into an injection-molding cavity. It is instead inserted into the injection-molding cavity, for manufacture of the component that is manufactured later, because it was manufactured in the same mold and can remain there. The component manufactured later can thus be injection-molded already in positive engagement with the component manufactured earlier. Joining assembly of the two components, which in the existing art were manufactured separately from one another, is thus no longer necessary. It is furthermore possible, in the manner typical of assembly injection-molding methods, to decrease the number of molds as compared with completely separate manufacture of each individual component.

Any components that are connected to one another by positive engagement on the completed motor vehicle air flap apparatus are appropriate, in principle, for use of the aforementioned assembly injection-molding step.

For example, at least a portion of the at least one air flap and a portion of the apparatus frame can be manufactured, connected to one another in positively engaged fashion, by an assembly injection-molding method in such a way that pivotable mounting of the at least one air flap at at least one of its longitudinal ends, preferably at both longitudinal ends, on the portion of the apparatus frame is already provided, in functional and operationally ready fashion, upon manufacture of the two aforesaid portions. This can be achieved by the fact that the two components encompass an air-flap-side air-flap bearing portion having a pivot bearing configuration, defining the pivot axis, for pivotable mounting of the air flap, and an apparatus-frame-side apparatus-frame bearing portion having a counterpart pivot bearing configuration, defining a bearing axis, for pivotable reception of the pivot bearing configuration having a pivot axis coaxial with the bearing axis. For example, one of the two bearing portions, preferably the air-flap bearing portion, can comprise a bearing stem that constitutes a pivot bearing configuration and projects from the remainder of the portion, the longitudinal center axis of which defines the pivot axis of the air flap. The respective other of the two portions, preferably the apparatus-frame bearing portion, can likewise comprise a bearing opening or bearing recess, which constitutes a counterpart pivot bearing configuration and through which the bearing stem passes in an operationally ready state. A longitudinal center axis of the bearing recess or bearing opening constitutes the bearing axis of the bearing recess or bearing opening. In the completely assembled state, i.e. in the completely injection-molded state in the present case, the bearing stem passes through the bearing opening or projects into the bearing recess, the pivot axis of the bearing stem and the bearing axis of the bearing recess or bearing opening then being arranged coaxially and thus enabling a pivoting motion of the bearing stem, and of a configuration connected thereto for motion together, relative to the apparatus-frame bearing portion around a defined pivot axis.

Preferably, firstly the portion comprising the bearing opening or bearing recess is manufactured by injection molding, and that portion is used as an insert in the assembly injection-molding method to manufacture the component or portion comprising the bearing stem. The pivotability in a bearing opening or bearing recess of a bearing stem manufactured using the assembly injection-molding method can be ensured by selection of suitable materials having suitable shrinkage behavior. It is simplest in this context to select for the bearing stem a material that shrinks more than for the component surrounding the bearing stem. The bearing stem can then, upon cooling after being manufactured by injection molding, shrink away from the bearing opening or bearing recess that surrounds it, and thus ensure low-friction relative rotatability.

The air-flap bearing portion can be a portion that is continuous in one piece with the air flap, on which portion the pivot bearing configuration is embodied. The air-flap bearing portion can also be a component that is separate from the remainder of the air flap body and is assembled together with the flap body to yield an air flap.

In order to facilitate the assembly steps (still necessary even when an assembly injection-molding method is used) for connecting components, provision can be made that the apparatus frame encompasses a base frame and the apparatus-frame bearing portion as separate components. The method then encompasses a step of connecting the apparatus-frame bearing portion to the base frame.

In addition or alternatively to pivotable mounting of the at least one air flap on the apparatus frame, the two components can encompass an air-flap-side air flap portion as well as an entraining arm, projecting from the air flap portion, for coupling an air flap to another component. The other component can be at least one other air flap having a parallel flap axis, so that the air flap and the at least one other air flap can be coupled for a pivoting motion together around respective parallel pivot axes. Additionally or alternatively, the other component can be part of a pivot drive system, so that the air flap can be coupled to the pivot drive system in order to transfer a driving force.

The aforesaid air flap portion can be the aforementioned air-flap bearing portion. In principle, when the air-flap bearing portion is a component separate from the remainder of the flap body, an attempt will be made to embody that portion in one piece with the aforesaid entraining arm. If this is not possible, however, for example because of the physical conformation of the air flap portion, simultaneous manufacture of the air flap portion and of the entraining arm, and positively engaged assembly thereof, is a very advantageous option.

Because the entraining arm and air flap portion are usually intended specifically not to execute a relative motion with respect to one another, mutually positively engaging portions of the air flap portion on the one hand and of the entraining arm on the other hand can be connected with a press fit by appropriate selection of the manufacturing sequence and of the respective material in terms of its shrinkage behavior. One component from among the entraining arm and air flap portion, preferably the entraining arm, which externally surrounds the respective other component, can be shrunk for that purpose into the respective other component.

For example, a portion of the aforementioned bearing stem can pass through an opening of the entraining arm. In addition or alternatively to shrinking of the entraining arm onto the portion of the bearing stem or onto another portion of the air flap portion, the portions passing in positively engaged fashion through one another can be shaped rotationally asymmetrically, so that a relative rotation of the entraining arm and air flap portion is reliably prevented.

It is, however, not only the relatively movable pivotable mounting of an air flap on the apparatus frame, and/or a connection of the air flap portion and entraining arm immovably relative to one another, that can be produced using the assembly injection-molding method. Additionally or alternatively, according to an advantageous refinement of the present invention the two components can encompass an air flap portion having an entraining arm projecting from the pivot axis, and a connecting strut for coupling the entraining arm to at least one entraining arm of at least one further air flap portion of at least one further air flap having a parallel flap axis and pivot axis. The entraining arm and the connecting strut can then be manufactured, using the assembly injection-molding method, to be already motion-transferring to one another. Preferably the connecting strut is movable relative to the entraining arm, in particular rotatable around the coupling point of the connecting strut and entraining arm. The statements made above regarding pivotable mounting of the air-flap bearing portion on the apparatus-frame bearing portion apply correspondingly to this rotational mounting of the entraining arm on the connecting strut: one configuration from among the entraining arm and connecting strut can comprise a projection that projects into a recess, surrounding the projection in the operationally ready state, in the respective other configuration, or that passes through an opening in the respective other configuration. With regard to materials selection and the manufacturing sequence of the projection on the one hand and the opening or recess on the other hand, reference is made to the statements above regarding pivotable mounting.

Once again, the aforesaid air flap portion can be preferably be the aforementioned air-flap bearing portion.

Preferably the air-flap bearing portion, the apparatus-frame bearing portion, the entraining arm, and the connecting strut are manufactured successively using the assembly injection-molding method, and become connected in positively engaged fashion to one another upon manufacture. As already stated above, the entraining arm can be embodied in one piece with the air-flap bearing portion or can be manufactured, using an assembly injection-molding method, separately therefrom but in a manner connected in positively engaged fashion thereto.

According to a preferred refinement of the present invention, the motor vehicle air flap apparatus encompasses a plurality of air flaps having mutually parallel flap axes and pivot axes, in order to allow the largest possible air passage opening to be opened or blocked for a flow through it. In this case one of the aforesaid components can be a component group made up of a plurality of air flap portions and/or entraining arms, which can be manufactured simultaneously using the assembly injection-molding method.

The air-flap bearing portion can be an end cap constituting a component embodied separately from the remainder of the flap body. One component from among the flap body and end cap can then comprise an insertion configuration that can be connectable, by insertion, to a counterpart insertion configuration of the respective other component. To ensure mechanical connection of the flap body and end cap, the insertion configuration and counterpart insertion configuration can be equipped with positively engaging latching means, for example with a latching projection and a latching recess. Preferably the flap body comprises a recess which constitutes a counterpart insertion configuration and into which a projection of the end cap, constituting an insertion configuration, is insertable. Because the flap body is preferably manufactured by extrusion when end caps are used, said body has in any case a recess extending along the flap axis. Alternatively or even additionally, a longitudinal end portion of the flap body can be inserted as a whole into a recess of the end cap, for example if an end portion of the end cap surrounds the flap body, preferably completely encirclingly surrounds it, when the air flap is in the assembled state.

The manufacturing method discussed here can accordingly encompass extrusion of a flap body along an extrusion axis, the extrusion axis proceeding parallel to the flap axis. The flap bodies can then be cut to the required length from an extruded longitudinal flap-body material.

In order to ensure relative mobility of the two components manufactured using the assembly injection-molding method, or also to ensure immobility thereof relative to one another, the two components can, as already set forth above, be manufactured by injection molding from thermoplastic materials having different shrinkage behaviors, in particular having different coefficients of thermal expansion.

Because the motor vehicle air flap apparatus discussed above imparts particular technical advantages to a motor vehicle, the present invention also relates to a vehicle having an air flap apparatus manufactured in accordance with the method described above, the air flap apparatus being received in an opening of the vehicle on the front side of the vehicle. The motor vehicle air flap apparatus preferably serves to control a cooling air flow to a coolant heat exchanger of the motor vehicle. In this case the passthrough opening offers access to the engine compartment of the vehicle.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is an exploded perspective view of a motor vehicle air flap apparatus according to the present invention, looking at the side that faces toward an engine compartment of a motor vehicle in the operationally ready state;

FIG. 2 is a perspective view of an assemblage, manufactured using the assembly injection-molding method, made up of air-flap-side end caps and an apparatus-frame bearing portion, looking at that side of the assemblage which faces toward the air flaps;

FIG. 3 is a perspective view of the assemblage of FIG. 2 viewed from that side of the assemblage which faces away from the air flaps;

FIG. 4 is an enlarged perspective depiction of flap bodies, entraining arms, a connecting strut, and an apparatus-frame bearing portion closer to a drive system, of FIG. 1; and

FIG. 5 is a detail view of an assemblage, manufactured using an assembly injection-molding method, of an end cap and entraining arm, depicting both the individual parts and an operationally ready assemblage.

### DESCRIPTION OF PREFERRED EMBODIMENTS

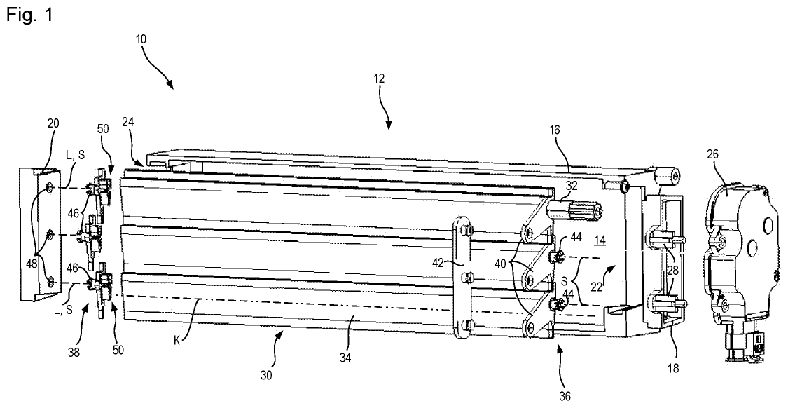

Referring now to the drawings wherein the showings are for the purpose of illustrating preferred and alternative embodiments of the invention only and not for the purpose of limiting the same, in FIG. 1, an embodiment according to the present invention of a motor vehicle air flap apparatus of the present application is labeled in general with the number 10. Air flap apparatus 10 encompasses an apparatus frame 12 that encloses an air passage opening 14.

Apparatus frame 12 encompasses a base frame 16 that completely surrounds air passage opening 14, as well as an apparatus-frame bearing portion 18 closer to the drive system and an apparatus-frame bearing portion 20 farther from the drive system. Bearing portions 18 and 20 are manufactured as separate components and can be installed on base frame 16, in respective corresponding cutouts 22 and 24 therein, to form apparatus frame 12.

An electrical drive system 26 can be attached on attachment configurations 28 on that side of apparatus-frame bearing portion 18 closer to the drive system which faces away from air passage opening 14. Electrical drive system 26 can then drive a plurality of air flaps 30 to move pivotably between the closed position shown in FIG. 1, in which air passage opening 14 is blocked by air flaps 30 for flow through it, and an open position which is pivoted with respect thereto and in which air flaps 30 permit flow through air passage opening 14.

Air flaps 30 extend along parallel flap axes K, only flap axis K of the bottommost air flap 30 being depicted in FIG. 1 in the interest of clarity.

Air flaps 30 are furthermore pivotable around parallel pivot axes S in order to move between the aforesaid operating positions (closed position and open position). Pivot axes S are parallel to flap axes K. For purposes of the present Application “parallel” means, in contrast to the term “coaxial,” that flap axes K and pivot axes S proceed in identical directions but are at a constant, non-negligible distance from one another orthogonally to that direction.

Air flap 30 that is topmost in FIG. 1 comprises, on its longitudinal end located closer to drive system 26, a stub hub 32 that is torque-transferringly couplable to an output member of drive system 26, for example to a hollow drive shaft not depicted in the Figures.

Air flaps 30 each encompass a flap body 34 that is manufactured as an extruded profile, as well as two end-located end caps 36 and 38. End caps 36 closer to the drive system mount flap body 34 pivotably on apparatus-frame bearing portion 18 closer to the drive system. End caps 38 farther from the drive system mount flap body 34 pivotably on apparatus-frame bearing portion 20 farther from the drive system. In contrast to end caps 38, end caps 36 closer to the drive system each comprise an entraining arm 40. The entraining arms are couplable by way of a connecting strut 42 for a pivoting motion together around their respective pivot axes S.

End caps 36 and 38 are arranged substantially mirror-symmetrically. The drive system end cap, carrying hub configuration 32, of the topmost air flap 30 in FIG. 1 is embodied discrepantly from the other end caps 36 closer to the drive system, since it comprises hub configuration 32.

End caps 36 and 38 each comprise a bearing stem 44 and 46, which respectively define pivot axis S of air flap 30 comprising end caps 36 and 38. In the operationally ready state, bearing stems 44 and 46 pass through bearing openings in the respective associated apparatus-frame bearing portion 18, 20. Only bearing openings 48 in apparatus-frame bearing portion 20 farther from the drive system are visible in FIG. 1. Center axes of bearing openings 48 form bearing axes L thereof. In an operationally ready configuration, pivot axes S of air flaps 30 are coaxial with the associated bearing axes L of apparatus-frame bearing portions 18 and 20 that mount them.

According to the present invention, for example, end caps 38 and apparatus-frame bearing portion 20 farther from the drive system are manufactured using the assembly injection-molding method. For this, preferably firstly apparatus-frame bearing portion 20 farther from the drive system, comprising bearing openings 48, is manufactured by injection molding, and it then serves as an insert in an injection-molding cavity for the manufacture of end caps 38. The latter are manufactured during the assembly injection-molding step in a manner that passes through and engages behind bearing openings 48, specifically from a material that preferably, upon thermal solidification from the processing temperature during injection molding to a common operating temperature with bearing portion 20, shrinks more than does the material of bearing portion 20. Bearing stems 46 can thus shrink away from bearing openings 48 that surround them, and can ensure smooth rotational mounting of end caps 38 on bearing portion 20.

The situation is correspondingly the same for end caps 36 and their bearing stems 44 with regard to apparatus-frame bearing portion 18 closer to the drive system.

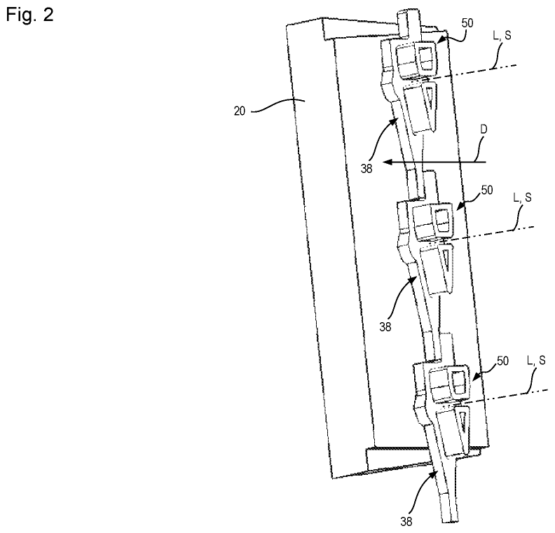

FIG. 2 shows in detail the assemblage made up of apparatus-frame bearing portion 20 and end caps 38, manufactured using the assembly injection-molding method. It shows how the end caps can be inserted through (two-part, in the example depicted) insertion projections 50 in corresponding insertion recesses of the extruded flap bodies 34 and thus can be connected to flap bodies 34 for motion together. The outer contour of each end cap 38 corresponds to the outer contour of the associated flap body 34 and thus to the outer contour of air flap 30. The manner in which portions of immediately adjacent air flaps 30 overlap in flowthrough direction D, in order to avoid undesired leakage gaps between adjacent air flaps 30, is evident in FIG. 2.

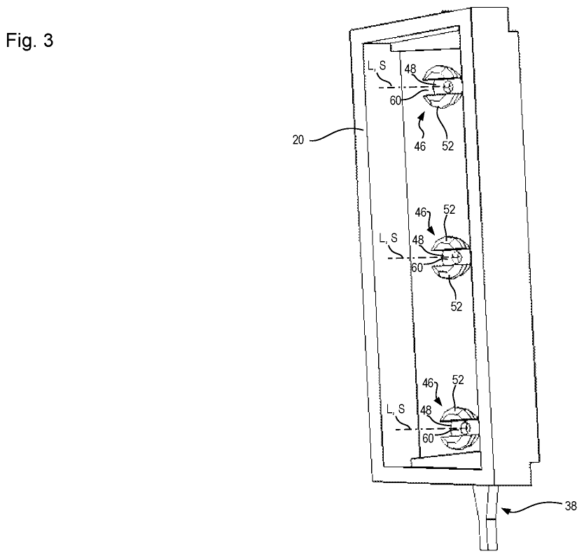

FIG. 3 depicts the back side of the assemblage of FIG. 2. It shows how radial latching projections 52 on the exposed longitudinal ends of bearing stems 46 engage behind the rims of bearing openings 48 and thereby hold end caps 38 in captive fashion on apparatus-frame bearing portion 20 until air flap apparatus 10 is completely assembled.

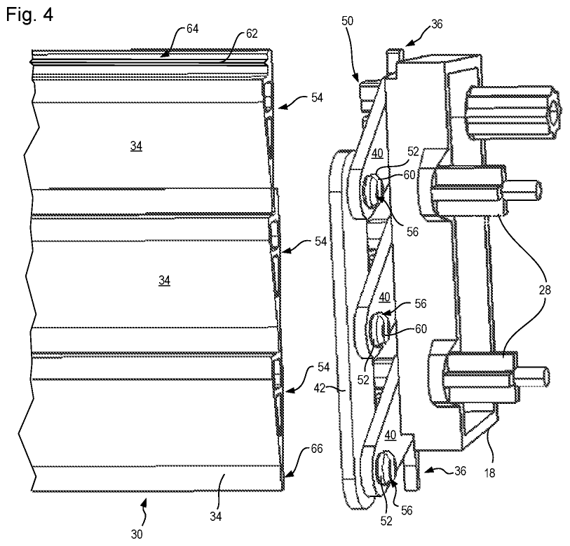

FIG. 4 shows insertion recesses 54 of flap bodies 34, into which insertion projections 50 of end caps 36 are introduced in order to connect flap body 34 and end cap 36 to one another. Bearing stems (not depicted) of end caps 36 are connected in the same manner to apparatus-frame bearing portion 18 closer to the drive system by assembly injection-molding, as has been explained with reference to FIGS. 2 and 3 for end caps 38 and apparatus-frame bearing portion 20 farther from the drive system.

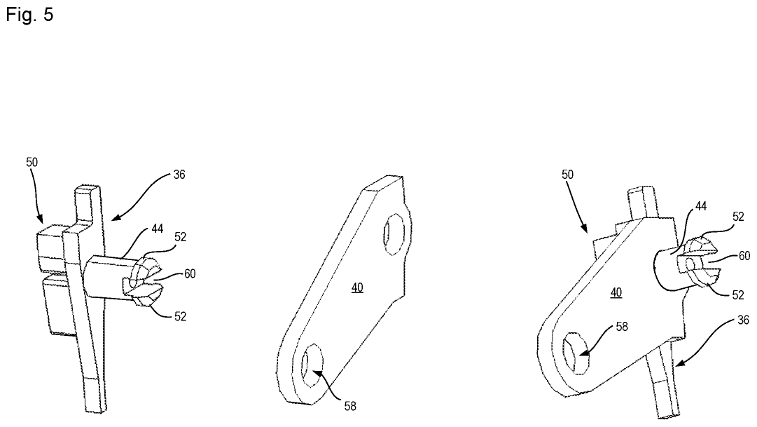

Entraining arms 40 and connecting strut 42 are also preferably manufactured using the assembly injection-molding technique so as to be connected to one another in relatively movable positive engagement, or more precisely latching engagement. In the interest of mobility-promoting release upon shrinkage, as recited above, preferably entraining arms 40 are firstly manufactured by injection molding, and they then serve as inserts in an injection-molding cavity for the manufacture of connecting strut 42. Connecting strut 42 comprises a plurality of projections 56, preferably exactly one for each entraining arm 40. Projections 56 pass through passthrough openings 58 (see FIG. 5) in entraining arms 40. The exposed longitudinal ends of projections 56 are embodied to engage behind passthrough openings 58 with radial latching projections 52, in the same manner as the free longitudinal ends of bearing stems 46. As in the case of bearing stems 44 and 46, a slit 60 extending axially from the exposed longitudinal end of projection 56 or of bearing stems 44 and 46, respectively into projection 56 or into bearing stems 44 and 46, and the radial deformability associated therewith, also provides the ability respectively to unmold bearing stems 44 and 46 or projection 56 from their respective primary-forming tools.

Slit 60 can also, however, serve to transfer torque, for example via hub configuration 32 to an end cap 36 and thus to an air flap 30.

It is thus not only end caps 36 and apparatus-frame bearing portion 18 closer to the drive system that can be manufactured together in operationally ready fashion by assembly injection molding, but also drive end cap 36 of the topmost air flap 30 in FIG. 1 and hub configuration 32.

Entraining arms 40 and end caps 36 can be manufactured in one piece by injection molding. That need not be the case, however. FIG. 5 shows an end cap 36 and an entraining arm 40 that is embodied separately therefrom and can likewise be manufactured in completely assembled fashion by assembly injection molding. For a maximally tight-fitting connection of entraining arm 40 and end cap 36 which ensures a mutually relatively immovable arrangement of entraining arm 40 and end cap 36, preferably firstly end cap 36 is manufactured by injection molding, and then a portion of bearing stem 44 is overmolded with entraining arm 40 using the assembly injection-molding method. The material used for entraining arm 40 is preferably one that, upon cooling from the processing temperature in the context of injection-molding to a shared operating temperature with end cap 46, shrinks more than does the material of end cap 36. Entraining arm 40 can thus, so to speak, be shrunk onto that portion of bearing stem 44 which carries it. Alternatively, bearing stem 44 can have a rotationally asymmetrical outer contour in the portion carrying entraining arm 40, so that entraining arm 40 is held nonrotatably on end cap 36 in positive engagement relative thereto.

Of the components described, several components connected to one another can also be manufactured successively using the assembly injection-molding method.

With a one-piece embodiment of entraining arm 40 and end cap 36, for example, apparatus-frame bearing portion 18 closer to the drive system can be manufactured in a first injection-molding step. End caps 36 are molded thereonto in rotatably mounted fashion using the assembly injection-molding method. Onto this assemblage, hub configuration 82 is molded onto bearing stem 44 of drive system end cap 36 (the topmost end cap, closer to the drive system, in FIG. 1), using the assembly injection-molding method. Connecting strut 42 is likewise not only generated in operationally ready fashion and in positive engagement with entraining arms 40, but simultaneously “assembled” onto entraining arms 40.

The assemblage of apparatus-frame bearing portion 20 and end caps 38 is likewise manufactured using the assembly injection-molding method. The two apparatus-frame bearing portions, fitted with end caps, are then connected by means of insertion configurations 50 to the respective longitudinal ends of flap bodies 34 by insertion into insertion recesses 54 thereof. The air flap assemblage thereby constituted is inserted, with its two apparatus-frame bearing portions 18 and 20, into the respective cutouts 22 and 24 on base frame 16. Base frame 16 is thus completed to yield apparatus 12, and air flap apparatus 10 is finished.

FIG. 4 furthermore shows an advantageous projection 62 on an abutment region 64 of the flap body which, in the closed position, is located oppositely from a counterpart abutment region 66 of a different flap body 34 or of base frame 12. The abutment surface area of abutment region 64 and counterpart abutment region 66 against one another is thereby advantageously reduced, which makes it easier to release movement blockages of air flaps 30 caused by icing, and to make air flaps 30 movable again.

Additionally or alternatively, a projection 62 can be embodied on the counterpart abutment region.

In order to achieve an optimum sealing effect, projection 62 extends over the entire length of abutment region 64 or counterpart abutment region 66 that carries it, and/or over the entire length of flap body 34. Projection 62 is preferably generated, upon extrusion of flap body 34, by a correspondingly shaped extrusion die.

In the interest of clarity, not all abutment regions 64 and counterpart abutment regions 66 are labeled with reference characters in FIG. 4.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A method for manufacturing a motor vehicle air flap apparatus for quantitatively controlling a cooling air flow in a vehicle space, the air flap apparatus encompassing: an apparatus frame having a passthrough opening; at least one air flap that extends along a flap axis and is mounted on the apparatus frame pivotably, around a pivot axis that is at least one of parallel to and coaxial with the flap axis, between two operational positions providing different coverage of the passthrough opening; such that the method for manufacturing at least some of the components of the motor vehicle air flap apparatus encompasses an injection-molding method,
wherein the method encompasses, for the manufacture of at least two components of the motor vehicle air flap apparatus which are connected to one another by positive engagement, an assembly injection-molding step with which one of the at least two components is manufactured in local positive engagement with a respective other of the at least two components.

12. The method according to claim 11, wherein the at least two components encompass an air-flap-side air-flap bearing portion having a pivot bearing configuration, defining the pivot axis, for pivotable mounting of the at least one air flap, and an apparatus-frame-side apparatus-frame bearing portion having a counterpart pivot bearing configuration, defining a bearing axis, for pivotable reception of the pivot bearing configuration having the pivot axis coaxial with the bearing axis.

13. The method according to claim 12, wherein the apparatus frame encompasses a base frame and the apparatus-frame bearing portion as separate components; and the method encompasses the step of connecting the apparatus-frame bearing portion to the base frame.

14. The method according to claim 11, wherein the at least two components encompass an air-flap-side air flap portion as well as an entraining arm, projecting from the air flap portion, for coupling an air flap of the least one air flap to at least one other air flap having a parallel flap axis, for at least one of a pivoting motion together around respective parallel pivot axes and for coupling to a pivot drive system.

15. The method according to claim 14, wherein the air-flap-side air flap portion is an air-flap bearing portion.

16. The method according to claim 11, wherein the at least two components encompass an air flap portion having a first entraining arm projecting from the pivot axis, and a connecting strut for coupling the first entraining arm to at least one other entraining arm of at least one further air flap portion of at least one further air flap having a parallel flap axis and pivot axis.

17. The method according to claim 16, wherein the air flap portion is an air-flap bearing portion.

18. The method according to claim 14, wherein the motor vehicle air flap apparatus comprises a plurality of air flaps having mutually parallel flap axes and pivot axes, one of the at least two components being a component group made up of the air flap portion and the entraining arm.

19. The method according to claim 16, wherein the motor vehicle air flap apparatus comprises a plurality of air flaps having mutually parallel flap axes and pivot axes, one of the at least two components being a component group made up of the air flap portion, at least one entraining arm and the connecting strut.

20. The method according to claim 12, wherein the air-flap bearing portion is an end cap.

21. The method according to claim 11, wherein the method further encompasses extrusion of a flap body along an extrusion axis, the extrusion axis proceeding parallel to the flap axis.

22. The method according to claim 11, wherein the at least two components are manufactured by injection molding from thermoplastic materials having different shrinkage behaviors.

23. The method according to claim 22, wherein the different shrinkage behaviors are different coefficients of thermal expansion.

24. A vehicle having an air flap apparatus manufactured in accordance with the method of claim 11, the air flap apparatus being received in an opening of the vehicle on the front side of the vehicle.
